(19) United States
(12) Patent Application Publication
(10) Pub. No.: US 2020/0180660 A1
(43) Pub. Date: Jun. 11, 2020

(54) VEHICLE AND APPARATUS AND METHOD FOR CONTROLLING THE SAME

(71) Applicant: HONDA MOTOR CO., LTD., Tokyo (JP)

(72) Inventor: Shigehiro HONDA, Wako-shi (JP)

(21) Appl. No.: 16/792,482

(22) Filed: Feb. 17, 2020

Related U.S. Application Data
(63) Continuation of application No. PCT/JP2017/031618, filed on Sep. 1, 2017.

(51) Int. Cl. B60W 60/00; B60W 40/06; B60W 50/14

(52) U.S. Cl. CPC B60W 60/0059; B60W 60/0057; B60W 60/0054; B60W 2050/0072; B60W 40/06; B60W 50/14; B60W 60/00184

(57) ABSTRACT

A control apparatus of a vehicle including a travel control unit that performs automated driving and actuators controlled by the travel control unit comprises a switching control unit that controls switching between the automated driving and manual driving, and a road surface determination unit that determines whether a road surface on which the vehicle is travelling satisfies a predetermined condition. When the switching control unit determines that the automated driving needs to be switched to the manual driving, the travel control unit performs the automated driving in a first mode when the road surface on which the vehicle is travelling satisfies the predetermined condition, and otherwise performs the automated driving in a second mode. A degree of deceleration in the automated driving in the second mode is greater than a degree of deceleration in the automated driving in the first mode.

### CROSS-REFERENCE TO RELATED APPLICATION(S)

This application is a continuation of International Patent Application No. PCT/JP2017/031618 filed on Sep. 1, 2017, the entire disclosure of which is incorporated herein by reference.

### BACKGROUND OF THE INVENTION

### Field of the Invention

The present invention relates to a vehicle and an apparatus and method for controlling the same.

### Description of the Related Art

Japanese Patent Laid-Open No. 9-161196 describes a control apparatus that controls switching between automated driving and manual driving of the vehicle. The control apparatus detects that the vehicle approaches a point where the automated driving is scheduled to be switched to the manual driving and forcibly decelerates the vehicle when the control apparatus determines that the switching from the automated driving to the manual driving will not be completed before the vehicle reaches the scheduled point.

### SUMMARY OF THE INVENTION

When the automated driving is switched to the manual driving, it is desirable to perform smooth handover of the driving control to the driver. An aspect of the present invention provides a technique for smoothly performing the handover performed when the automated driving is switched to the manual driving.

According to part of embodiments, there is provided a control apparatus of a vehicle including a travel control unit that performs automated driving and an actuator group controlled by the travel control unit, the control apparatus comprising a switching control unit that controls switching between the automated driving and manual driving and a road surface determination unit that determines whether a road surface on which the vehicle is travelling satisfies a predetermined condition, wherein when the switching control unit determines that the automated driving needs to be switched to the manual driving, the travel control unit performs the automated driving in a first mode when the road surface on which the vehicle is travelling satisfies the predetermined condition and performs the automated driving in a second mode when the road surface on which the vehicle is travelling does satisfy the predetermined condition, and wherein a degree of deceleration in the automated driving in the second mode is greater than a degree of deceleration in the automated driving in the first mode.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings are incorporated in and constitute part of the specification, illustrate an embodiment of the present invention and, together with the description thereof, serve to explain the principles of the present invention.

FIG. 1 is a block diagram of a vehicle according to an embodiment.

FIG. 2 is a functional block diagram for achieving an example of processes carried out by a control apparatus according to the embodiment.

FIG. 3 is a flowchart showing an example of the processes carried out by the control apparatus according to the embodiment.

FIG. 4 describes changes in speed in various deceleration modes in the embodiment.

### DESCRIPTION OF THE EMBODIMENTS

Embodiments of the present invention will be described below with reference to the accompanying drawings. Similar elements have the same reference character through a variety of embodiments, and duplicate description will be omitted. Further, the embodiments can be changed and combined with each other as appropriate.

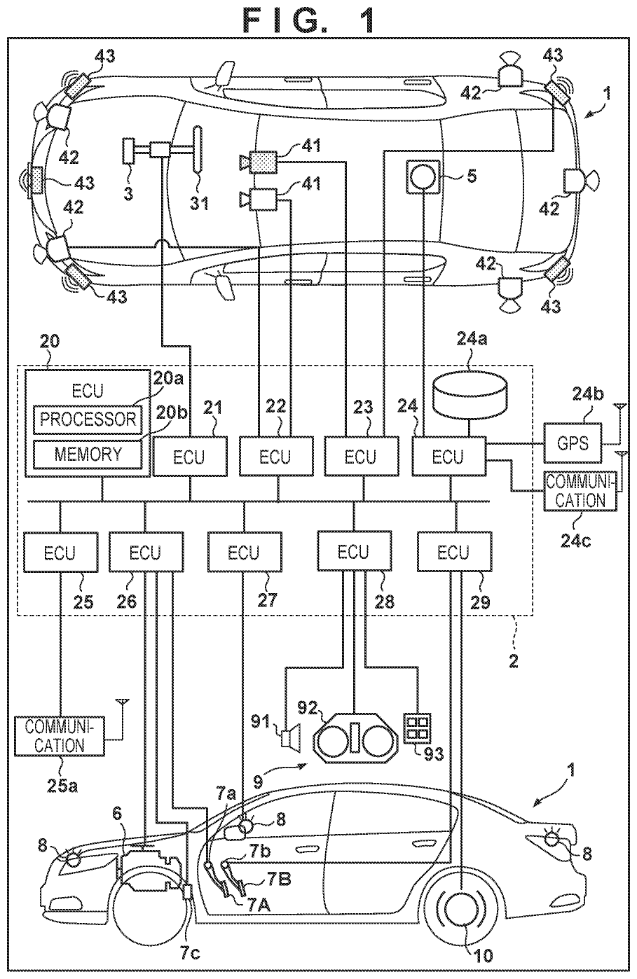

FIG. 1 is a block diagram of a control apparatus for vehicle according to an embodiment of the present invention, which controls a vehicle 1. In FIG. 1, the vehicle 1 is schematically shown in the form of a plane view and a side view. The vehicle 1 is a sedan-type, four-wheeled passenger car by way of example.

The control apparatus in FIG. 1 includes a control unit 2. The control unit 2 includes a plurality of ECUs 20 to 29 communicably connected to each other via an in-vehicle network. The ECUs each include a processor represented by a CPU, a memory, such as a semiconductor memory, an interface with an external device, and other components. The memory stores a program executed by the processor, data used when the processor carries out a process, and other pieces of information. The ECUs may each include a plurality of processors, memories, interfaces, and other components. For example, the ECU 20 includes a processor 20a and a memory 20b. When the processor 20a executes an instruction contained in the program stored in the memory 20b, the ECU 20 carries out a process. Alternatively, a dedicated integrated circuit that carries out the processes carried out by the ECU 20, such as an ASIC, may be provided.

The function and other factors for which each of the ECUs 20 to 29 is responsible will be described below. The number of ECUs and the functions for which the ECUs are responsible can be designed as appropriate, and the ECUs can each be divided into smaller portions than in the present embodiment or can be integrated with each other.

The ECU 20 performs control relating to automated driving of the vehicle 1. In the automated driving, the ECU 20 automatically controls at least one of the steering and/or acceleration/deceleration of the vehicle 1. In control example described later, the ECU 20 automatically controls both the steering and acceleration/deceleration.

The ECU 21 controls a motorized power steering device 3. The motorized power steering device 3 includes a mechanism that steers the front wheels in accordance with a driver's driving operation (steering operation) of a steering wheel 31. The motorized power steering device 3 includes a motor that assists the steering operation and produces driving force for automatically steering the front wheels, a sensor that senses the steering angle, and other components. When the driving state of the vehicle 1 is the automated driving, the ECU 21 automatically controls the motorized power steering device 3 in correspondence with an instruction from the ECU 20 to control the travel direction of the vehicle 1.

The ECUs 22 and 23 control sensing units 41 to 43, which each sense the situation around the vehicle, and processes information on the results of sensing. The sensing unit 41 is a camera (hereinafter referred to as camera 41 in some cases) that captures an image of a region in front of the vehicle 1, and in the present embodiment, the sensing unit 41 is formed of two cameras provided at a front portion of the roof of the vehicle 1. Analysis of images captured with the cameras 41 allows extraction of the contour of a target object and extraction of a divider line (such as white line) that separates lanes on a road from each other.

The sensing unit 42 is a lidar (light detection and ranging) (hereinafter referred to as lidar 42 in some cases), senses a target object around the vehicle 1, and measures the distance to the target object. In the present embodiment, the lidar 42 is formed of five lidars, with two lidars provided at opposite corners of a front portion of the vehicle 1, one lidar provided at the center of a rear portion of the vehicle 1, and two lidars provided at opposite sides of the rear portion of the vehicle 1. The sensing unit 43 is a millimeter-wave radar (hereinafter referred to as radar 43 in some cases), senses a target object around the vehicle 1, and measures the distance to the target object. In the present embodiment, the radar 43 is formed of five radars, with one radar provided at the center of a front portion of the vehicle 1, two radars provided at opposite corners of the front portion of the vehicle 1, and two radars provided at opposite corners of a rear portion of the vehicle 1.

The ECU 22 controls one of the cameras 41 and the lidars 42 and processes information on the results of the sensing performed thereby. The ECU 23 controls the other camera 41 and the radars 43 and processes information on the results of the sensing performed thereby. Providing two sets of devices that sense the situation around the vehicle allows improvement in reliability to the sensing results, and providing different kinds of sensing units, such as the cameras, lidars, and radars, allows multifaceted analysis of the environment around the vehicle.

The ECU 24 controls a gyro sensor 5, a GPS sensor 24b, and a communication device 24c and processes information on the results of sensing or communication performed thereby. The gyro sensor 5 senses the rotational motion of the vehicle 1. The result of the sensing performed by the gyro sensor 5, the wheel speed, and other factors allow determination of the travel route of the vehicle 1. The GPS sensor 24b senses the current position of the vehicle 1. The communication device 24c wirelessly communicates with a server that provides map information and traffic information and acquires the information. The ECU 24 can access a database 24a constructed in a memory and containing map information and the ECU 24, for example, searches for a route from the current location to a destination. The ECU 24, the map database 24a, and the GPS sensor 24b form what is called a navigation device.

The ECU 25 includes a communication device 25a for inter-vehicle communication. The communication device 25a performs wireless communication with other vehicles around the vehicle 1 to perform inter-vehicle information exchange.

The ECU 26 controls a power plant 6. The power plant 6 is a mechanism that outputs driving force that rotates the driving wheels of the vehicle 1 and includes, for example, an engine and a transmission. The ECU 26, for example, controls the output from the engine in correspondence with the driver's driving operation (accelerator pedal operation or acceleration operation) sensed with an operation sensing sensor 7a provided at an accelerator pedal 7A and switches a gear ratio to another in the transmission based on information such as the vehicle speed sensed with a vehicle speed sensor 7c. When the driving state of the vehicle 1 is the automated driving, the ECU 26 automatically controls the power plant 6 in correspondence with an instruction from the ECU 20 to control the acceleration/deceleration of the vehicle 1.

The ECU 27 controls lighting elements (such as headlights and taillights) including direction indicators 8 (blinkers). In the example shown in FIG. 1, the direction indicators 8 are provided at a front portion, door mirrors, and a rear portion of the vehicle 1.

The ECU 28 controls an input/output device 9. The input/output device 9 outputs information to the driver and receives information input from the driver. A voice output device 91 notifies the driver of information in the form of voice. A display device 92 notifies the driver of information in the form of a displayed image. The display device 92 is disposed, for example, on a surface facing the driver's seat and forms, for example, an instrument panel. Voice and a displayed image have been presented above by way of example, and the information may instead be notified in the form of vibration or light. The information may still instead be notified in the form of the combination of a plurality ones of voice, a displayed image, vibration, and light. Further, the combination or the notification form may be changed in accordance with the level of information to be notified (degree of urgency, for example). An input device 93 is disposed in a position where the driver can operate the input device 93 and is a switch group that issues an instruction to the vehicle 1. The input device 93 may further include a voice input device.

The ECU 29 controls a brake device 10 and a parking brake (not shown). The brake device 10 is, for example, a disk brake device, is provided at each of the wheels of the vehicle 1, and decelerates or stops the vehicle 1 by exerting resistance to the rotating wheels. The ECU 29 controls the action of the brake device 10 in correspondence with the driver's driving operation (braking operation) sensed with an operation sensing sensor 7b provided at a brake pedal 7B. When the driving state of the vehicle 1 is the automated driving, the ECU 29 automatically controls the brake device 10 in correspondence with an instruction from the ECU 20 to control the deceleration and stoppage of the vehicle 1. The brake device 10 and the parking brake can be activated to maintain the state in which the vehicle 1 is stopped. In a case where the transmission of the power plant 6 includes a parking lock mechanism, the parking lock mechanism can be activated to maintain the state in which the vehicle 1 is stopped.

### Control Example

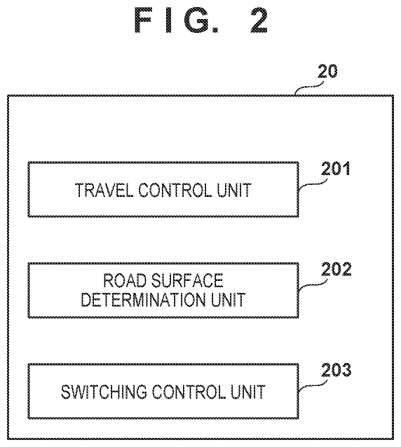

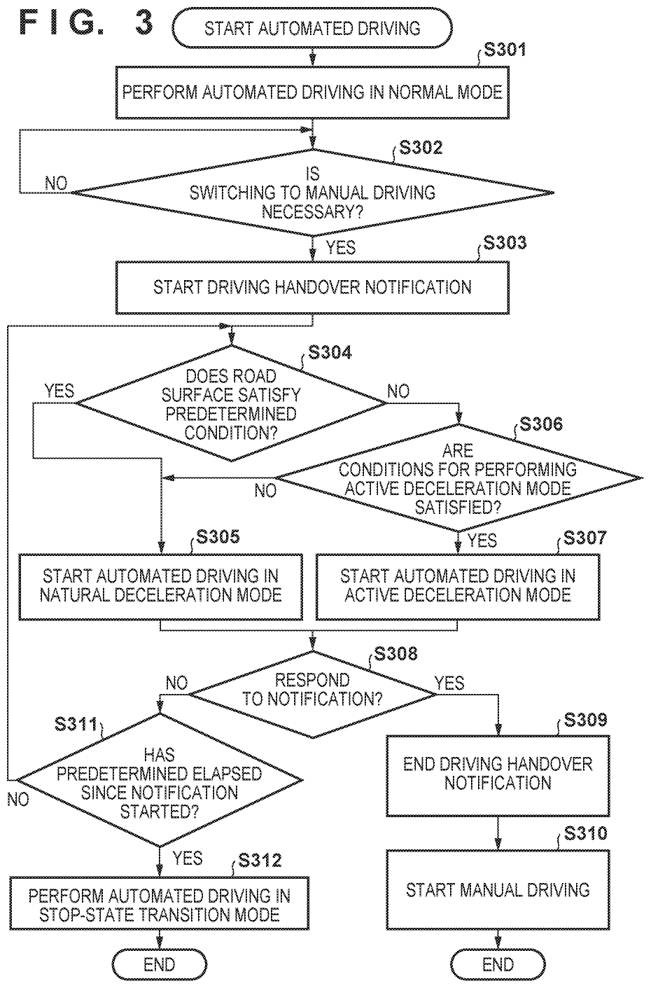

An example of the control of the vehicle 1 performed by the ECU 20 will be described with reference to FIGS. 2 and 3. FIG. 3 is a flowchart for describing the action performed after the automated driving starts. FIG. 2 describes the functions of the ECU 20 for carrying out the flowchart shown in FIG. 3. The ECU 20 functions as a control apparatus that controls the vehicle 1.

The ECU 20 includes a travel control unit 201, a road surface determination unit 202, and a switching control unit 203. The travel control unit 201, the road surface determination unit 202, and the switching control unit 203 may each be achieved by a dedicated circuit, such as an ASIC (application specific integrated circuit), or may be achieved by a general-purpose processor, such as a CPU, executing a program read into a memory. The travel control unit 201 performs the automated driving of the vehicle 1 based on the results of detection performed with sensors that sense the state of the vehicle 1 and the situation around the vehicle 1 (sensing units 41 to 43, wheel speed sensor, yaw rate sensor, and G sensor, for example). Specifically, the travel control unit 201 outputs control instructions to the ECUs 21, 26, and 29 to control an actuator group including a steering actuator, a braking actuator, and a driving actuator of the vehicle 1 in such a way that the vehicle 1 automatically travels irrespective of the driver's driving operation. The travel control unit 201 sets a travel route of the vehicle 1 and refers to the result of position recognition performed by the ECUs 22 and 23 and surrounding environment information (result of sensing of target object) to cause the vehicle 1 to travel along the set travel route. The road surface determination unit 202 determines whether the road surface on which the vehicle 1 is travelling satisfies a predetermined condition. The switching control unit 203 controls the switching between the automated driving and the manual driving. In the present embodiment, one ECU 20 functions as each of the travel control unit 201, the road surface determination unit 202, and the switching control unit 203, and ECUs may instead be provided on a function basis.

The action performed after the automated driving starts will subsequently be described with reference to FIG. 3. The following description will be made of the case where the ECU 20 performs the action. The flowchart shown in FIG. 3 starts, for example, when the driver of the vehicle 1 instructs start of the automated driving.

In step S301, the ECU 20 (travel control unit 201) performs the automated driving in a normal mode. The normal mode is a mode in which the steering, driving, and braking are all performed as required to try to reach a destination.

In step S302, the ECU 20 (switching control unit 203) determines whether switching to the manual driving is necessary. In a case where the switching is necessary (“YES” in S302), the ECU 20 proceeds to the process in step S303, whereas in a case where the switching is unnecessary (“NO” in S302), the ECU 20 repeats the step S302. The ECU 20 determines that the switching to the manual driving is necessary, for example, when it is determined that part of the functions of the vehicle 1 has deteriorated, when it is difficult to continue the automated driving due to a change in the surrounding traffic conditions, or when the vehicle 1 has reached a point in the vicinity of a destination set by the driver.

In step S303, the ECU 20 (switching control unit 203) starts driving handover notification. The driving handover notification is notification for requesting the driver to switch to the manual driving. The actions in subsequent steps S304 to S308, S311, and S312 are performed during the driving handover notification.

In step S304, the ECU 20 (road surface determination unit 202) determines whether the road surface on which the vehicle is travelling satisfies the predetermined condition. When the predetermined condition is satisfied (“YES” in step S304), the ECU 20 proceeds to the process in step S305, whereas when the predetermined condition is not satisfied (“NO” in step S304), the ECU 20 proceeds to the process in step S306.

The predetermined condition may contain a condition that the road surface is not, for example, a low-μ road surface (road surface having low frictional coefficient) or a rugged road surface. A specific example of a low-μ road surface may include a frozen road surface and a snow covered road surface.

The ECU 20 may determine whether the road surface satisfies the predetermined condition based on at least any of the result of detection performed by an interior sensor of the vehicle 1, the result of detection performed by an exterior sensor of the vehicle 1, and/or the content of communication performed between the vehicle 1 and a device external thereto. Specifically, in the case where the state of the road surface is determined based on the result of detection performed by the interior sensor of the vehicle 1, the ECU 20 may perform the determination based on the yaw rate, the lateral acceleration, the wheel speed, the throttle opening, or the brake pedal pressing force. For example, the ECU 20 may determine that the road surface is a low-μ road surface when the ratio of the vehicle speed to the wheel speed is low as compared with the ratio in the case of a typical road surface. When the result of the detection shows that the wheels are slipping or skidding, the ECU 20 can estimate the frictional coefficient of the road surface based also on the throttle opening that causes the slipping or the brake pedal pressing force that causes the skidding. Further, the ECU 20 can, for example, sense the yaw rate and the lateral acceleration with sensors and compare the sensed yaw rate and lateral acceleration with those determined from the speed and the steering angle of the vehicle 1 to sense the skidding of the vehicle based on the degree of coincidence between the two yaw rates and lateral acceleration values. The ECU 20 can then estimate the degree of the frictional coefficient of the road surface, for example, also from the speed and the steering angle that cause the skidding. The ECU 20 can determine that the current road surface is a low-μ road surface when the estimated frictional coefficient of the road surface is smaller than a predetermined threshold.

To determine the state of the road surface based on the result of the detection performed by the exterior sensor of the vehicle 1, the ECU 20 may use, for example, the outside temperature acquired with an outside temperature sensor and the range of visibility identified from the distance to a target object provided from the lidars 42. When image recognition of images captured with the cameras 41 shows that the road surface is entirely white, the ECU 20 can determine that the road surface is covered with snow. When the outside temperature sensor has sensed that the current outside temperature is below zero (or temperature below zero and lower or equal to predetermined temperature), the ECU 20 may determine that the road surface is frozen. Further, for example, when a sensor, such as the lidars 42 and the radars 43, determines that the rotating wheels are lifting snow, the ECU 20 can determine that the road surface is covered with snow.

To determine the state of the road surface based on the content of communication between the vehicle 1 and a device external thereto, the ECU 20 may use, for example, information provided from a vehicle information and communication systems (VICS), information received from another vehicle, and weather information. For example, the information from VICS may contain information on a region where freezing or snow accumulation has occurred.

The situation in which the road surface on which the vehicle is travelling is a rugged road surface may also be determined by the same method such as that used to determine the road surface on which the vehicle is travelling is a low-μ road surface. The rugged road, for example, has a road surface wet with rain or an insufficiently paved road surface.

In step S305, the ECU 20 (travel control unit 201) starts the automated driving in a natural deceleration mode. The natural deceleration mode is a mode in which only the steering is performed as required to wait for the driver's response to the driving handover notification. In the natural deceleration mode, no active braking is performed by the ECU 23A, but the vehicle 1 is decelerated by engine braking or regenerative braking. When the road surface on which the vehicle is travelling satisfies the predetermined condition, performing no active braking allows reduction in the degree of discomfort felt by the driver in the driving handover.

In step S306, the ECU 20 (travel control unit 201) determines whether the conditions for performing an active deceleration mode have been satisfied. When the conditions have been satisfied (“YES” in step S306), the ECU 20 proceeds to the process in step S307, whereas when the conditions have not been satisfied (“NO” in step S306), the ECU 20 proceeds to the process in step S305. The conditions for performing the active deceleration mode will be described later.

In step S307, the ECU 20 (travel control unit 201) starts the automated driving in the active deceleration mode. The active deceleration mode is a mode in which the steering is performed as required to wait for the driver's response to the driving handover notification with the vehicle 1 decelerated by a greater degree than in the natural deceleration mode. To increase the degree of deceleration, the ECU 20 may perform braking using the braking actuator (frictional braking, for example), may use deceleration regeneration (for example, by increasing the amount of regeneration), or may use engine braking (for example, by changing a gear ratio to lower one). Further, the ECU 20 may start the deceleration at an earlier timing than in the natural deceleration mode to decelerate the vehicle 1 by an increased degree. In the case where the road surface on which the vehicle is travelling does not satisfy the predetermined condition, it is believed that handing over the driving to the driver with the vehicle 1 having low kinetic energy allows smooth handover to the driver. To this end, the ECU 20 starts the automated driving in the active deceleration mode to actively lower the speed of the vehicle 1 to lower the kinetic energy of the vehicle 1.

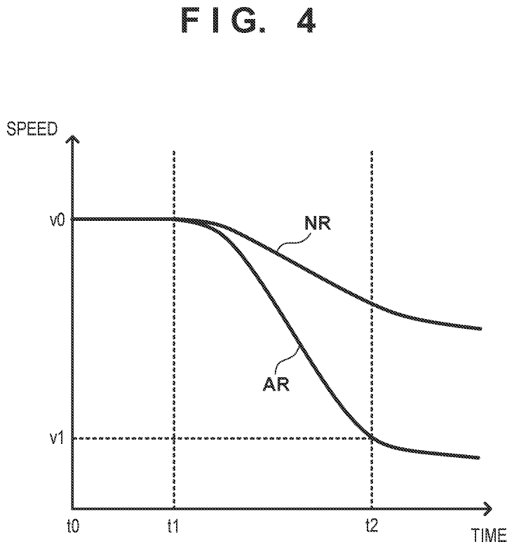

Changes in the speed in the deceleration modes will be described with reference to FIG. 4. The graph NR shows a change in the speed of the vehicle 1 in the natural deceleration mode, and the graph AR shows a change in the speed of the vehicle 1 in the active deceleration mode. It is assumed that the vehicle speed at time t0 is v0 and the vehicle 1 travels at a fixed speed. At time t1, the determination in step S302 is performed, and the result of the determination shows that the switching to the manual driving is necessary. The vehicle 1 is then decelerated in any of the deceleration modes, and the active deceleration mode allows faster deceleration than the natural deceleration mode, as shown in FIG. 4. That is, the speed at the same point of time is slower in the active deceleration mode than in the natural deceleration mode.

Even in the case where the road surface on which the vehicle is travelling does not satisfy the predetermined condition, it is unnecessary in some cases to actively lower the speed of the vehicle 1, for example, when the vehicle 1 has already traveled at a sufficiently low speed. Therefore, in the present embodiment, when the conditions for performing the active deceleration mode have not been satisfied in step S306, the automated driving in the active deceleration mode does not start, but the automated driving in the natural deceleration mode starts. The conditions described above may be based, for example, on the travelling state of the vehicle 1. Specifically, the active deceleration mode may be performed when the vehicle speed of the vehicle 1 is equal to a threshold speed (for example, legal speed limit on a road along which the vehicle 1 is travelling: 20 km/hour). If the vehicle speed is lowered to a value smaller than the threshold speed, the difference in speed between the vehicle 1 and the other vehicles increases, so that the handover is in contrast unlikely to be smoothly performed. The threshold speed can be called a deceleration end speed in the active deceleration mode. That is, in the active deceleration mode, the deceleration is actively performed until the deceleration end speed is reached, and the active deceleration mode transitions to the natural deceleration mode when the deceleration end speed is reached. For example, it is assumed in FIG. 4 that the vehicle speed in the active deceleration mode reaches a deceleration end speed v1 at time t2. In this case, the ECU 20 performs the deceleration in the natural deceleration mode after the time t2. The conditions described above may be based, for example, on the situation of detection performed by the exterior sensor and the current travelling vehicle speed. Specifically, when the sensing performance of the exterior sensor lowers from 100 m to 50 m as a result of deterioration of the function of the exterior sensor, the active deceleration mode may be performed when the vehicle speed is higher than or equal to the speed that does not allows the vehicle 1 to avoid an unexpected event that occurs at a point in front of the vehicle 1 by 50 m.

In step S308, the ECU 20 (switching control unit 203) determines whether the driver has responded to the driving handover notification. When the driver has responded (“YES” in step S308), the ECU 20 proceeds to the process in step S309, whereas when the driver has not responded (“NO” in step S308), the ECU 20 proceeds to the process in step S311. The driver can show the drier's intention of transition to the manual driving, for example, via the input device 93. The driver may instead show the drier's intention of agreement based on the result of detection of the driver's steering detected by a steering torque sensor.

In step S309, the ECU 20 (switching control unit 203) terminates the driving handover notification. In step S310, the ECU 20 (travel control unit 201) terminates the automated driving in the natural deceleration mode or the active deceleration mode being performed and starts the manual driving. In the manual driving, the ECUs of the vehicle 1 each control the travelling of the vehicle 1 in accordance with the driver's driving operation. Since the performance of the ECU 20 is likely to have, for example, deteriorated, the ECU 28 may cause the display device 92 to output a message that prompts the driver to take the vehicle 1 to a repair shop.

In step S311, the ECU 20 (switching control unit 203) determines whether a predetermined period (period according to automated driving level of vehicle 1, for example, 4 seconds or 15 seconds) has elapsed since the start of the driving handover notification. When the predetermined period has elapsed (“YES” in S311), the ECU 20 proceeds to the process in step S312, whereas when the predetermined period has not elapsed (“NO” in S311), the ECU 20 returns to the process in step S304 and repeats the processes in step S304 and the following steps.

In step S312, the ECU 20 (travel control unit 201) terminates the automated driving in the natural deceleration mode or the active deceleration mode being performed and performs the automated driving in a stop-state transition mode. The stop-state transition mode is a mode that causes the vehicle 1 to be stopped in a safe position or the vehicle speed to be decelerated to a speed slower than the deceleration end speed in the active deceleration mode. Specifically, the ECU 20 searches for a position where the vehicle 1 can be stopped while actively decelerating the vehicle 1 to a speed slower than the deceleration end speed in the active deceleration mode. When a stoppable position has been successfully found, the ECU 20 stops the vehicle 1 at the position, whereas when no stoppable position has been successfully found, the ECU 20 searches for a stoppable position while causing the vehicle 1 to travel at a very slow speed (creep speed, for example). The ECU 20 then determines whether the vehicle 1 has stopped based on the result of the sensing performed by a rotational speed sensor. When the ECU 20 determines that the vehicle 1 has stopped, the ECU 20 instructs the ECU 29 to activate the motorized parking lock device to maintain the state of the stopped vehicle 1. When the automated driving is performed in the stop-state transition mode, a hazard lamp or any other display device may be used to notify other vehicles around the vehicle 1 that the vehicle 1 is transitioning to a stop state, or the communication device may be used to notify other vehicles and other terminal devices of the same. During the automated driving in the stop-state transition mode, the ECU 20 may perform deceleration control according to whether or not there is any vehicle that follows the vehicle 1. For example, the ECU 20 may increase the degree of the deceleration in a case where there is no vehicle that follows the vehicle 1 to a degree greater than the degree of the deceleration in a case where there is a vehicle that follows the vehicle 1.

In the action described above, the automated driving starts in step S305 or S307 after the driving handover notification starts in step S303. The driving handover notification may instead start after the automated driving starts in step S305 or S307.

Specific scenarios of the action described above will be described below. In a first scenario, when the functions of the travel control unit and the actuator group have deteriorated, the driving handover notification starts. After the driving handover notification starts, the ECU 20 starts the automated driving in the active deceleration mode when the road surface on which the vehicle is travelling is, for example, a low-μ road surface. When the speed of the vehicle 1 sufficiently lowers during the automated driving in the active deceleration mode, so that the conditions for performing the active deceleration mode are not satisfied, the ECU 20 causes the automated driving in the active deceleration mode to transition to the automated driving in the natural deceleration mode. Thereafter, when the driver responds to the driving handover notification, the ECU 20 terminates the driving handover notification and starts the manual driving.

In a second scenario, although the function of the travel control unit or the actuator group has not deteriorated, the driving handover notification starts in accordance with a change in the surrounding traffic conditions. After the driving handover notification starts, the ECU 20 starts the automated driving in the natural deceleration mode when the road surface on which the vehicle is travelling is a typical road surface. It is assumed that during the automated driving in the natural deceleration mode, the road surface on which the vehicle is travelling changes to a low-μ road surface, and that the conditions for performing the active deceleration mode are satisfied. In this case, the ECU 20 causes the automated driving in the natural deceleration mode to transition to the automated driving in the active deceleration mode. The ECU 20 then causes the automated driving in the active deceleration mode to transition to the automated driving in the stop-state transition mode when the predetermined period has elapsed since the start of the driving handover notification.

The above embodiment has been described with reference to the case where the driving, braking, and steering are all automated as the automated driving control performed by the ECU 20 in the automated driving mode. The automated driving control may instead control at least one of the driving, braking, and/or steering irrespective of the driver's driving operation. It can be said that the control irrespective of the driver's driving operation include a situation in which the control is performed even when no driver's input is made to an operation component represented by the steering handle and the pedals, or that the driver's intention of driving the vehicle is not essential to the control. Therefore, the driver may be responsible for monitoring the surroundings, and the automated driving control may control at least one of the driving, braking, and/or steering of the vehicle 1 in accordance with the information on the environment around the vehicle 1; the driver may be responsible for monitoring the surroundings, and the automated driving control may control the steering of the vehicle 1 and at least one of the driving and/or braking thereof in accordance with the information on the environment around the vehicle 1; or the driver is not responsible for monitoring the surroundings, and the automated driving control may control all the driving, braking, and steering of the vehicle 1 in accordance with the information on the environment around the vehicle 1. Further, the automated driving control may be capable of transition to any of the control stages described above. Moreover, a sensor that senses information on the state of the driver (biological information, such as heart beat, or information on the state of driver's facial expression or driver's pupil) may be provided, and the automated driving control may be performed and suppressed in accordance with the result of the sensing performed by the sensor.

In the embodiment described above, the automated driving control performed by the ECU 20 may be driving assistance control (or travelling assistance control), that is, may control at least one of the driving, braking, and/or steering during the driver's driving operation. It can be said that during the driver's driving operation is a case where there is the driver's input made to an operation component or a case where the driver's contact with an operation component can be detected and the driver's intention of driving the vehicle is read. The driving assistance control can include both driving assistance control performed by the driver's selecting of activation thereof, for example, via switch operation and driving assistance control performed without the driver's selecting of the activation thereof. Examples of the former case in which the driver selects the activation of the driving assistance control may include preceding car tracking control and lane maintaining control. These types of control can also be defined as part of the automated driving control. Examples of the latter case in which the driving assistance control is performed without the driver's selecting of the activation thereof may include collision suppression braking control, lane deviation suppression control, and erroneous travel start suppression control.

### SUMMARY OF EMBODIMENT

### [Configuration 1]

A control apparatus (20) of a vehicle (1) including a travel control unit (201) that performs automated driving and an actuator group controlled by the travel control unit, the control apparatus comprising:

a switching control unit (203) that controls switching between the automated driving and manual driving; and

a road surface determination unit (202) that determines whether a road surface on which the vehicle is travelling satisfies a predetermined condition, wherein

when the switching control unit determines that the automated driving needs to be switched to the manual driving, the travel control unit

performs the automated driving in a first mode when the road surface on which the vehicle is travelling satisfies the predetermined condition, and

performs the automated driving in a second mode when the road surface on which the vehicle is travelling does satisfy the predetermined condition, and

wherein a degree of deceleration in the automated driving in the second mode is greater than a degree of deceleration in the automated driving in the first mode.

According to the configuration described above, when the road surface on which the vehicle is travelling is, for example, a low-μ road surface, the automated driving in a mode in which the degree of deceleration is large is performed, so that the speed at each point of time during the driving handover notification decreases, whereby the handover at the time of switching from the automated driving to the manual driving is smoothly performed.

### [Configuration 2]

The control apparatus described in the configuration 1, wherein when the switching control unit determines that the automated driving needs to be switched to the manual driving, the switching control unit issues driving handover notification for requesting a driver to switch to the manual driving.

According to the configuration described above, the driver can recognize that switching to the manual driving is necessary.

### [Configuration 3]

The control apparatus described in the configuration 2, wherein after a predetermined period elapses since start of the driving handover notification, the travel control unit terminates the automated driving being performed in the first or second mode and starts the automated driving in a third mode, and

in the automated driving in the third mode, the travel control unit stops the vehicle or decelerates the vehicle to a speed slower than a deceleration end speed in the second mode.

According to the configuration described above, in the automated driving in a mode in which the vehicle is stopped, the automated driving in the other modes has ended, whereby control interference can be avoided.

### [Configuration 4]

The control apparatus described in the configuration 2 or 3, wherein when the driver responds to the driving handover notification, the travel control unit terminates the automated driving being performed in the first or second mode and starts the manual driving.

According to the configuration described above, since the manual driving starts after the handover, driving according to the driver's intention is achieved, whereby the driver can control the vehicle in an improved manner.

### [Configuration 5]

The control apparatus described in any one of the configurations 1 to 4, wherein the predetermined condition includes a condition that the road surface is not a low-μ road surface, a snow covered road surface, or a rugged road surface.

According to the configuration described above, a preferable automated driving mode can be determined in the case where the road surface is a low-μ road surface, a snow covered road surface, or a rugged road surface.

### [Configuration 6]

The control apparatus described in any one of the configurations 1 to 5, wherein the road surface determination unit determines whether the road surface on which the vehicle is travelling satisfies the predetermined condition based on at least any of
a result of detection performed by an interior sensor of the vehicle,
a result of detection performed by an exterior sensor of the vehicle, and/or
a content of communication performed between the vehicle and a device external thereto.

According to the configuration described above, the state of the road surface can be appropriately sensed.

### [Configuration 7]

The control apparatus described in any one of the configurations 1 to 6, wherein during the automated driving in the second mode, the travel control unit causes the automated driving in the second mode to transition to the automated driving in the first mode based on a travelling state of the vehicle.

According to the configuration described above, the handover can be performed more safely by lowering the degree of the deceleration when the speed is sufficiently low.

### [Configuration 8]

A vehicle comprising:

the control apparatus described in any one of the configurations 1 to 7;

a travel control unit that performs automated driving; and

an actuator group controlled by the travel control unit.

According to the configuration described above, a vehicle that allows smooth handover at the time of switching from the automated driving to the manual driving is provided.

### [Configuration 9]

A method for controlling a vehicle (1) including a travel control unit (201) that performs automated driving and an actuator group controlled by the travel control unit, the method comprising:

determining whether a road surface on which the vehicle is travelling satisfies a predetermined condition (S304);

when it is determined that the automated driving needs to be switched to manual driving,
performing the automated driving in a first mode when the road surface on which the vehicle is travelling satisfies the predetermined condition (S305); and
performing the automated driving in a second mode when the road surface on which the vehicle is travelling does not satisfy the predetermined condition (S307),

wherein a degree of deceleration in the automated driving in the second mode is greater than a degree of deceleration in the automated driving in the first mode.

According to the configuration described above, when the road surface on which the vehicle is travelling is, for example, a low-μ road surface, the automated driving in a mode in which the degree of deceleration is large is performed, whereby the handover at the time of switching from the automated driving to the manual driving is smoothly performed.

The present invention is not limited to the above embodiment and various changes and modifications can be made within the spirit and scope of the present invention. Therefore, to apprise the public of the scope of the present invention, the following claims are made.

What is claimed is:

1. A control apparatus of a vehicle including a travel control unit that performs automated driving and an actuator group controlled by the travel control unit, the control apparatus comprising:
a switching control unit that controls switching between the automated driving and manual driving; and
a road surface determination unit that determines whether a road surface on which the vehicle is travelling satisfies a predetermined condition, wherein
when the switching control unit determines that the automated driving needs to be switched to the manual driving, the travel control unit
performs the automated driving in a first mode when the road surface on which the vehicle is travelling satisfies the predetermined condition, and
performs the automated driving in a second mode when the road surface on which the vehicle is travelling does satisfy the predetermined condition, and
wherein a degree of deceleration in the automated driving in the second mode is greater than a degree of deceleration in the automated driving in the first mode.

2. The control apparatus according to claim 1, wherein when the switching control unit determines that the automated driving needs to be switched to the manual driving, the switching control unit issues driving handover notification for requesting a driver to switch to the manual driving.

3. The control apparatus according to claim 2, wherein after a predetermined period elapses since start of the driving handover notification, the travel control unit terminates the automated driving being performed in the first or second mode and starts the automated driving in a third mode, and
in the automated driving in the third mode, the travel control unit stops the vehicle or decelerates the vehicle to a speed slower than a deceleration end speed in the second mode.

4. The control apparatus according to claim 2, wherein when the driver responds to the driving handover notification, the travel control unit terminates the automated driving being performed in the first or second mode and starts the manual driving.

5. The control apparatus according to claim 1, wherein the predetermined condition includes a condition that the road surface is not a low-μ road surface, a snow covered road surface, or a rugged road surface.

6. The control apparatus according to claim 1, wherein the road surface determination unit determines whether the road surface on which the vehicle is travelling satisfies the predetermined condition based on at least any of
a result of detection performed by an interior sensor of the vehicle,
a result of detection performed by an exterior sensor of the vehicle, and/or
a content of communication performed between the vehicle and a device external thereto.

7. The control apparatus according to claim 1, wherein during the automated driving in the second mode, the travel control unit causes the automated driving in the second mode to transition to the automated driving in the first mode based on a travelling state of the vehicle.

8. A vehicle comprising:
the control apparatus according to claim 1;
a travel control unit that performs automated driving; and
an actuator group controlled by the travel control unit.

9. A method for controlling a vehicle including a travel control unit that performs automated driving and an actuator group controlled by the travel control unit, the method comprising:
determining whether a road surface on which the vehicle is travelling satisfies a predetermined condition;
when it is determined that the automated driving needs to be switched to manual driving,
performing the automated driving in a first mode when the road surface on which the vehicle is travelling satisfies the predetermined condition; and
performing the automated driving in a second mode when the road surface on which the vehicle is travelling does not satisfy the predetermined condition,
wherein a degree of deceleration in the automated driving in the second mode is greater than a degree of deceleration in the automated driving in the first mode.
